(19) United States
(12) Patent Application Publication
(10) Pub. No.: US 2025/0178899 A1
(43) Pub. Date: Jun. 5, 2025

(54) STRONG GAS PROCESS AND APPARATUS FOR SULFURIC ACID PRODUCTION

(71) Applicants: NORAM Engineering and Constructors Ltd., Vancouver (CA); THE UNIVERSITY OF BRITISH COLUMBIA, Vancouver (CA)

(72) Inventors: Arian EBNEYAMINI, Vancouver (BC); Andrés MAHECHA-BOTERO, North Vancouver (CA); John GRACE, Vancouver (BC); Brian FERRIS, Vancouver (CA); Choon Jim LIM, Vancouver (CA); Kamonchanok SIRIKAN, Vancouver (CA); Zezhong LI, Vancouver (CA)

(21) Appl. No.: 18/525,644

(22) Filed: Nov. 30, 2023

(51) Int. Cl. C01B 17/50

(52) U.S. Cl. CPC C01B 17/503

(57) ABSTRACT

A process and apparatus for producing sulfuric acid are disclosed. The process comprises reacting a sulfur species and a strong oxygen gas to produce a process gas comprising sulfur dioxide; oxidizing the sulfur dioxide gas to produce a process gas comprising sulfur trioxide; and hydrating the sulfur trioxide to produce sulfuric acid, and a used process gas. The concentration of oxygen in the source of strong oxygen gas is greater than about 21 vol. %. The process may further comprise purging the used process gas, thereby producing a process purge gas and a process recycle gas, and recirculating at least part of the process recycle gas into one or more upstream processes. The process recycle gas and process purge gas each comprises an excess concentration of sulfur dioxide gas of greater than about 12 vol. %, or an excess concentration of oxygen gas of greater than about 21 vol. %.

### FIELD OF THE INVENTION

The invention pertains to processes and apparatuses for sulfuric acid production.

### BACKGROUND

Processes and apparatuses for sulfuric acid production are known in the art. Conventional sulfuric acid plants are prone to overheating of the sulfur dioxide oxidation reactor (i.e., catalytic converter), which may be attributed to the exothermic nature of the sulfur dioxide oxidation. Such overheating of the catalytic converter mostly occurs in the first stage of catalytic conversion (i.e., first catalyst bed). This disadvantageously creates several technical and practical challenges, pertaining both to safety and efficiency in the operation of the acid plant system. Overheating can cause, among other issues, damage of process equipment, catalyst deactivation, loss of process control, and environmental as well as safety issues. Few methods and systems have been proposed to mitigate the overheating issue in sulfuric acid plants. However, such prior art methods typically require large process gas flow rate due to requirements of external dilution (which may require large-sized equipment to deal with increased gas flows and create heat losses), complex equipment designs (e.g., requiring complex cooling schemes), high SOx emissions, and/or increased number of unit operations. This present invention is directed to improved processes and apparatuses of producing sulfuric acid with reduced unwanted overheating in sulfuric acid plants, while minimizing gas emissions and the number and size of equipment required to achieve desirable performance in the acid plant system.

### SUMMARY

The present invention provides processes and apparatuses for producing sulfuric acid by replacing at least part of the process gases with an excess concentration of catalytic oxidation reactants (sulfur dioxide gas or oxygen gas). In some embodiments, the excess sulfur dioxide gas or excess oxygen gas replaces at least part of the inert gases contained in the process gas to produce a process gas containing an excess concentration of sulfur dioxide gas (or also referred to as strong sulfur dioxide gas) or excess oxygen gas (or also referred to as strong oxygen gas). The present process is adapted to co-produce sulfuric acid and excess sulfuric dioxide or excess oxygen gas. At least part of the used process gas containing such excess sulfuric dioxide or excess oxygen gas are recirculated as process recycle gas for use in the sulfuric acid production process to replace or supplement the source of excess sulfuric dioxide or excess oxygen gas in the process gas. The process is configured such that the process recycle gas is substantially free of sulfuric trioxide.

The excess concentration of catalytic oxidation reactants may serve as thermal heat sink and performance booster (e.g., thermodynamics and/or kinetics) in the sulfuric acid plant. This advantageously allows for reduction of the required pieces and/or sizes of unit operations, as well as address issues of equipment overheating in the acid plant. Other improvements to the acid plant such as enhanced heat recovery and/or reduction or elimination of SOx and/or reduction of nitrogen content within the system, thereby reducing or eliminating of NOx emissions may also be attainable through certain process configurations and operating conditions of the present invention.

In some embodiments, a process for producing sulfuric acid comprises reacting a source of sulfur species and a source of strong oxygen gas in a sulfur dioxide generation unit to produce a process gas comprising sulfur dioxide; supplying the process gas comprising sulfur dioxide gas to a catalytic converter configured to oxidize the sulfur dioxide gas to produce a process gas comprising sulfur trioxide; and supplying the process gas comprising sulfur trioxide to an absorption/condensation/hydration unit operations configured to hydrate the sulfur trioxide to produce sulfuric acid, and a used process gas. In some embodiments, the concentration of oxygen in the source of strong oxygen gas is greater than about 21 vol. %.

In some embodiments, the process further comprises purging at least part of the used process gas, thereby producing a stream of process purge gas and a stream of process recycle gas, and recirculating at least part of the process recycle gas into one or both of the sulfur dioxide generation unit and the catalytic converter. In some embodiments, the streams of process recycle gas and process purge gas each comprises an excess concentration of sulfur dioxide gas of greater than about 12 vol. %, or an excess concentration of oxygen gas of greater than about 21 vol. %.

Plant performance (e.g., high yield and/or high selectivity co-production of sulfuric acid and strong oxygen gas or strong sulfur dioxide, etc.) may be optimized by adjusting one or more of recycle and process gas composition, recycle and process gas flow rate, oxygen concentration in the source of strong oxygen gas, argon/nitrogen concentration in the source of strong oxygen, system pressure, and the equipment available in the sulfuric acid plant, and one or more of the following non-limiting ways to modify the plant configuration:
The process recycle gas arranged to be withdrawn from a single unit operation or multiple unit operations in the system.
The withdrawn process recycle gas arranged to be supplied to a single unit operation or multiple unit operations in the system.
The source of strong oxygen gas arranged to be supplied to a single unit operation or multiple unit operations in the system.

The processes and apparatuses of the present invention may be applied to any suitable sulfuric acid plant configuration, and may be most suitable at sites where co-production of sulfuric acid and a strong sulfur dioxide gas or a strong oxygen gas is desired. In some embodiments, the co-production of sulfuric acid and a strong sulfur dioxide gas or a strong oxygen gas may additionally co-produce one or more of nitrogen, argon, and other rare gases in air (such as neon, krypton, xenon, etc.) in the step of producing the strong oxygen gas from an air supply at an upstream air separation unit.

Further aspects of the invention and features of specific embodiments of the invention are described below.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 is an example process flow diagram illustrating a basic embodiment of the invention.

FIG. 2 is a process flow diagram illustrating an example embodiment of the invention.

FIG. 3 is a detailed process flow diagram illustrating the FIG. 2 embodiment.

FIG. 4 is a detailed process flow diagram illustrating another example embodiment of the invention.

FIG. 5 is a process flow diagram illustrating another example embodiment of the invention.

FIG. 6 is a process flow diagram illustrating another example embodiment of the invention.

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

### Definitions

“Absorption/condensation/hydration unit operation” refers to a unit operation which is configured to generate a liquid sulfuric acid product. Examples of such unit operation include sulfur trioxide gas absorption towers, irrigated packed towers, quench towers, gas condensers, etc.

“Acid decomposition unit operations” refers to the process equipment and unit operations configured to decompose sulfuric acid and/or spent sulfuric acid to produce a gas containing sulfur oxides. The gas comprising sulfur oxides may comprise predominantly sulfur dioxide gas.

“Catalytic oxidation reactants” refers to sulfur dioxide (SO₂) and oxygen (O₂), which are the two predominant reactants used in a SO₂ oxidation reaction.

“Equilibrium shift” refers to any condition(s) and/or configuration(s) at which the thermodynamic equilibrium of at least one major reaction in the sulfuric acid production process (e.g., sulfur burning, ore smelting, sulfur dioxide gas oxidation, sulfur trioxide gas hydration, etc.) is favorably shifted in the sulfuric acid plant. Non-limiting examples of “equilibrium shift” are conditions and/or configurations at which the thermodynamic equilibrium of sulfur dioxide gas oxidation is shifted toward greater sulfur dioxide gas oxidation in the catalytic converter for a particular set of operating conditions.

“Flue gas” refers to any gaseous stream generated through burning a fuel using an oxygen-containing gas (e.g., air, strong oxygen gas, etc.). Non-limiting examples of fuels include any types of hydrocarbon fuels.

“Inert gas” includes any unreactive gases in the sulfuric acid plant. Non-limiting examples of inert gases are nitrogen (N₂) and Argon (Ar).

“Process intensification” refers to any condition(s) and/or configuration(s) at which the number and/or size of the process equipment and/or unit operations is reduced in the sulfuric acid plant.

“Pyrometallurgical extraction unit operations” refers to the process equipment and unit operations configured to process sulfide ores (e.g., copper, lead, zinc, nickel, etc.) to produce a gas containing sulfur oxides. The processing of sulfide ores may comprise one or more of calcining, roasting, and/or refining of sulfide ores. The gas comprising sulfur oxides may comprise predominantly sulfur dioxide gas.

“Rate boost” refers to any condition(s) and/or configuration(s) at which the rate of at least one major reaction in the sulfuric acid production process is favorably increased in the sulfuric acid plant. Non-limiting examples of “rate boost” are conditions and/or configurations at which the reaction rate of sulfur dioxide gas oxidation is accelerated in the catalytic converter for a particular set of operating conditions.

“Recycle system” refers to a unit operation which is configured to convey at least part of the process gas from downstream of the process performed in the absorption/condensation/hydration unit operation into an upstream process. Examples of such unit operations include process gas blowers and fans.

“Source” refers to any process feedstock that is fed into the process.

“Spent sulfuric acid” refers to diluted, contaminated, and/or partially neutralized sulfuric acid. Spent sulfuric acid may be obtained as a byproduct of an industrial chemical or refinery plant.

“Strong gas” or “excess gas” refers to any gaseous stream that is rich or concentrated in sulfur dioxide and/or oxygen gas. The term “strong oxygen gas” (strong O₂ gas) or “excess oxygen gas” includes any strong gas with a minimum oxygen gas concentration of about 21 vol. %. The term “strong sulfur dioxide gas” (strong SO₂ gas) or “excess sulfur dioxide gas” includes any strong gas with a minimum sulfur dioxide gas concentration of about 12 vol. %.

“Sulfur dioxide generation unit operations” refers to any process and unit operation that generates sulfur dioxide gas from a source of sulfur species. Non-limiting examples of sulfur dioxide generation units are the sulfur burner in sulfur-burning acid plants, ore smelter in pyrometallurgical acid plants, and acid regeneration furnace in acid regeneration plants.

“Sulfur dioxide oxidation” refers to the reaction in which sulfur dioxide (SO₂) is oxidized to sulfur trioxide (SO₃) by oxygen. Sulfur dioxide oxidation may occur in the presence of a catalyst. Sulfur dioxide oxidation is performed in unit operations configured to convert SO₂ into SO₃. Examples of such unit operations comprise packed bed catalytic converters containing one or more catalyst beds.

“Sulfur oxides” (SOₓ) comprises sulfur dioxide and sulfur trioxide, which are the two predominant intermediate reactants used in sulfuric acid plants.

“Sulfuric acid” or “H₂SO₄” includes any phase and form of sulfuric acid, including but not limited to liquid, vapor, and aerosol.

“Sulfuric acid plant” refers to the process equipment and unit operations configured to convert sulfur compounds (e.g., sulfur, H₂S, etc.) to sulfur dioxide gas using sulfur dioxide generation unit operations. The sulfur dioxide gas is then catalytically oxidized to form sulfur trioxide gas. The formed sulfur trioxide gas is absorbed/condensed/hydrated to produce sulfuric acid. Non-limiting examples of sulfuric acid plant configurations include sulfur-burning acid plants, pyrometallurgical acid plants, acid regeneration plants, acid gas treatment plants, and wet acid plants.

“Thermal heat sink” refers to any gaseous medium that dissipates thermal energy (i.e., heat) in process equipment and unit operations.

### Overview of Sulfuric Acid Production Process and Apparatus

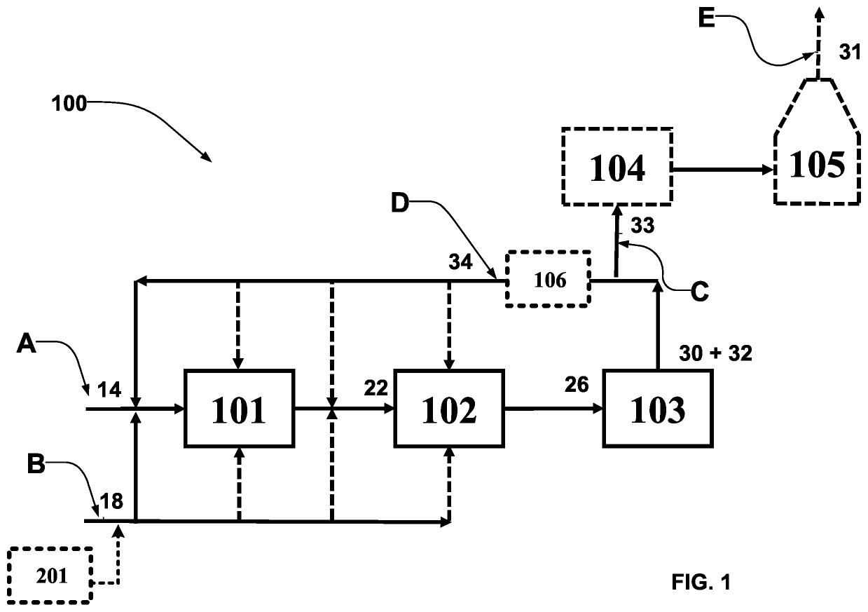

Referring to FIG. 1, the sulfuric acid production process may be performed in a sulfuric acid plant system 100 comprising at least a sulfur dioxide generation unit operations 101 configured to generate sulfur dioxide gas, a catalytic sulfur dioxide converter 102 configured to convert sulfur dioxide gas to sulfur trioxide gas, and an absorption/condensation/hydration unit operations 103 configured to produce a sulfuric acid product.

The process may comprise supplying a source of sulfur species 14 through a sulfur stream (A) and supplying a source of strong oxygen gas 18 through an oxygen stream (B) to the sulfur dioxide generation unit operations 101 within which the source of sulfur species 14 is caused to react with the source of strong oxygen gas 18 to generate a process gas comprising sulfur dioxide 22.

The source of sulfur species 14 may comprise any suitable source that contains sulfur compounds, including but not limited to elemental sulfur(S) (including its allotropes), sulfur dioxide, hydrogen sulfide (H₂S), sulfur trioxide (SO₃), sulfuric acid (H₂SO₄), mercaptans (R-SH), sulfide ores, etc.

The source of strong oxygen gas contains an oxygen concentration that is greater than about 21 vol. %, and in some embodiments, greater than about 80 vol. %, and in some embodiments, greater than about 90 vol. %. The source of strong oxygen gas may provide the required oxygen gas for sulfur dioxide and/or sulfur trioxide generation in the sulfuric dioxide generation unit 101 and catalytic sulfur dioxide converter 102 respectively, and/or the required oxygen gas needed to maintain excess sulfur dioxide or oxygen gas concentration in the process gas. The source of strong oxygen gas 18 may be produced from a process or unit operation upstream of the sulfur dioxide generation unit operations 101. In some example embodiments, producing the source of strong oxygen gas 18 comprises separating oxygen gas from an air supply at an upstream air separation unit 201. The upstream air separation unit 201 may be configured to perform one or more of a cryogenic air separation process, pressure/vacuum-swing adsorption process, membrane separation process, etc. Any other suitable unit operations that are configured to produce a concentrated oxygen gas stream may be flowingly connected to the sulfur dioxide generation unit operations 101 and/or the catalytic sulfur dioxide converter 102 to supply the source of strong oxygen gas 18 to the sulfuric acid production process. In some embodiments, the source of strong oxygen gas 18 is supplied upstream of or directly into the sulfur dioxide generation unit 101. In some embodiments, the source of strong oxygen gas 18 is supplied upstream of or directly into the catalytic converter 102. The source of strong oxygen gas 18 may be supplied upstream of or in-situ or downstream of a specific one or more catalyst beds within the catalytic converter 102. In some embodiments, the production of the source of strong oxygen gas 18 at the upstream air separation unit 201 additionally produces other gases, such as argon, krypton, xenon, etc.

The sulfur dioxide generation unit 101 comprises one or more apparatuses or unit operations configured to generate sulfur dioxide by reacting the source of sulfur species 14 with the source of strong oxygen gas 18. The one or more apparatuses that form the sulfur dioxide generation unit 101 may vary depending on the configuration of the sulfuric acid plant. In one example, a sulfur dioxide generation unit operation 101 for a pyrometallurgical acid plant may comprise a smelter, one or more gas cleaning units, heat exchange units, gas blowers, and gas dryers. In another example, a sulfur dioxide generation unit operations 101 for a sulfur-burning acid plant may comprise a sulfur burner, one or more gas blowers, gas dryers, and heat exchange units. Example processes of this invention advantageously allow for the elimination of certain unit operation(s), and/or reduction of the size of certain unit operation(s) such as gas blower, gas dryer, etc. to achieve the desired plant performance (e.g., high yield and/or high selectivity co-production of sulfuric acid and strong oxygen gas or strong sulfur dioxide, etc.).

In some example embodiments, the sulfur dioxide generation unit 101 is maintained at a temperature between about 800° C. and about 2,000° C. In embodiments in which the sulfur dioxide generation unit 101 comprises a sulfur burner, the temperature may be maintained between about 900° C. and about 1,600° C. The excess sulfur dioxide gas or the excess oxygen gas contained in the process gas may serve as additional thermal heat sink to assist with maintaining the temperature of the sulfur dioxide generation unit 101 within the desired temperature range.

The process gas comprising sulfur dioxide 22 is supplied to the catalytic converter 102 within which the process gas comprising sulfur dioxide 22 is caused to react with oxygen gas to form a process gas comprising sulfur trioxide 26. In some example embodiments, the below oxidation reaction is proposed to occur within catalyst bed comprising V₂O₅-based catalysts:

$${SO}_{2} + \frac{1}{2} {O}_{2} ↔ {SO}_{3} \qquad Equation 1$$

$$Δ {H}_{298}^{0} = - 99 kJ \cdot {mol}^{- 1}$$

The catalytic converter 102 may comprise one or more catalyst beds (or contact stages), and optionally one or more heat exchange units. The one or more catalyst beds may comprise a suitable catalyst (such as V₂O₅-based catalysts) adapted to catalyze the conversion of a process gas comprising sulfur dioxide 22 into a process gas comprising sulfur trioxide 26. Any suitable number of catalyst beds may be provided. As used herein, one catalyst bed comprises one layer of catalyst filled therein. The number of catalyst beds may be adjusted depending on factors such as process configuration, operating conditions, and/or the desired performance (e.g., allowable SOₓ emissions). In some embodiments, less than three catalyst beds are provided. In some embodiments, the number of catalyst beds provided is in the range of from one to five, and in some embodiments, one to three, and in some embodiments, only one catalyst bed is provided. In some example embodiments, the oxidation reaction is performed at a gas temperature below about 650° C., and in some embodiments, between about 370° C. to about 650° C., and in some embodiments, between about 400° C. and about 630° C. The excess sulfur dioxide gas or the excess oxygen gas contained in the process gas may serve as additional thermal heat sink to assist with maintaining the temperature of the catalytic converter 102 within the desired temperature range.

The process gas comprising sulfur trioxide 26 may be supplied to the absorption/condensation/hydration unit operations 103 within which at least part of or substantially all of the process gas comprising sulfur trioxide 26 is hydrated with process water to form a product stream comprising sulfuric acid 30. In an example embodiment, the below hydration reaction is proposed to occur at the absorption/condensation/hydration unit operations 103:

$${SO}_{3} + {H}_{2} O \to {H}_{2} {SO}_{4} \qquad Equation 2$$

$$Δ {H}_{298}^{0} = - 1 \; 01 kJ \cdot {mol}^{- 1}$$

The absorption/condensation/hydration unit operations 103 may comprise gas coolers, absorption/condensation/hydration equipment (e.g., an absorber, condenser, etc.), and/or acid mist removal devices. Some conventional sulfuric acid plants require two absorption/condensation/hydration unit operations 103. Example processes of this invention require that only one absorption/condensation/hydration unit operations 103 be arranged in the sulfuric acid plant to achieve the desired plant performance. In some example embodiments, the absorption/condensation/hydration unit operations 103 comprises a gas-liquid absorption contactor. The hydration reaction within the gas-liquid absorption contactor may be operated at a temperature between about 5 and 300° C., and in some embodiments, between about 25° C. and about 200° C., and in some embodiments, between about 70° C. and about 120° C. In some other example embodiments, the absorption/condensation/hydration unit operations 103 comprises a sulfuric acid cooler-condenser or a packed absorption tower. The sulfuric acid cooler-condenser may for example comprise shell and tube heat exchangers.

The product stream comprising sulfuric acid 30 is arranged to flow out of the absorption/condensation/hydration unit operations 103. The product stream comprising the sulfuric acid 30 may optionally be caused to flow through one or more downstream unit operations 104 flowingly connected downstream of the absorption/condensation/hydration unit operations 103. The one or more downstream unit operations 104 comprise for example one or more sets of conversion/hydration unit operations and/or tail gas cleaning systems configured to purify the product stream 30 to remove undesired contaminants contained therein. A sulfuric acid plant stack 105 may optionally be arranged downstream of the absorption/condensation/hydration unit operations 103. Gas and/or an acid plant byproduct 31 may be caused to be emitted from the sulfuric acid plant stack 105. Waste gas may be caused to be discharged to the atmosphere through a gas discharge stream (E).

The hydration reaction between sulfur trioxide and process water may additionally form a used process gas 32. The used process gas 32 is arranged to flow out of the absorption/condensation/hydration operation unit operations 103. In some embodiments, the used process gas 32 is dry. The used process gas 32 may be substantially free of sulfur trioxide gas (i.e., having a sulfur trioxide gas content in the used process gas 32 of less than about 10 vol. %, and in some embodiments, less than about 2 vol. %, and in some embodiments, less than about 0.1 vol. %). The used process gas 32 comprises an excess concentration of sulfur dioxide gas (or strong sulfur dioxide gas) or an excess concentration of oxygen gas (or strong oxygen gas). In embodiments in which the used process gas 32 comprises excess or strong sulfur dioxide gas, the concentration of sulfur dioxide contained in the used process gas 32 is greater than 12 vol. % sulfur dioxide, in some embodiments, between about 30 and about 95 vol. % sulfur dioxide, and in some embodiments, between about 60 and about 85 vol. % sulfur dioxide. In embodiments in which the used process gas 32 comprises excess or strong oxygen gas, the concentration of the oxygen gas contained therein is greater than 21 vol. % oxygen gas, and in some embodiments, between about 25 and about 95 vol. % oxygen gas, and in some embodiments, between about 30 and about 50 vol. % oxygen gas. The used process gas 32 may additionally comprise one or more inert gases. The one or more inert gases may have a concentration contained in the used process gas 32 of between about 1 and about 79 vol. %, and in some embodiments, between about 5 and about 75 vol. %, and in some embodiments, between about 15 and about 70 vol. %. In some embodiments, the one or more inert gases comprises argon.

In some embodiments, at least part of the used process gas 32 is purged, for example by means of operating a gas valve. The purging of the at least part of the used process gas 32 comprises adjusting the flow rate at which the used process gas 32 is purged and/or controlling the amount of the used process gas 32 that is purged at a level so as to maintain in the process recycle gas 34 an excess concentration of oxygen gas or an excess concentration of sulfur dioxide gas. Gas purged from the process 33 (or the process purge gas 33) may be discharged via a purge gas stream (C) to serve as a plant by-product or be discharged to the atmosphere via a plant stack with or without further gas processing at a processing facility or cleaning at a scrubbing unit. The process purge gas 33 may comprise excess sulfuric dioxide gas or excess oxygen gas, and optionally one or more inert gases such as Argon. At least some or substantially all of the process gas 32 remaining after the purging may be caused to be recirculated into one or more upstream unit operations for use in the one or more upstream processes via recycle stream (D) as process recycle gas 34. The process recycle gas 34 containing excess sulfur dioxide gas or excess oxygen gas may serve to supplement the source of strong oxygen gas or the source of strong sulfur dioxide in the process gas.

In embodiments in which the process recycle gas 34 contains excess sulfur dioxide gas, the process recycle gas 34 is in the range of from about 30 to 100 vol. % of the used process gas 32, and in some embodiments, in the range of from about 30 to 99 vol. %, and in some embodiments, in the range of from about 50 to 99 vol. %, and in some embodiments, in the range of from about 80 to 95 vol. %.

In embodiments in which the process recycle gas 34 contains excess oxygen gas, the process recycle gas 34 is in the range of from about 30 to 100 vol. % of the used process gas 32, and in some embodiments, in the range of from about 30 to 99 vol. %, and in some embodiments, in the range of from about 80 to 100 vol. %, and in some embodiments, in the range of from about 80 to 99 vol. %, and in some embodiments, in the range of from about 95 to 100 vol. %, and in some embodiments, in the range of from about 95% to 99 vol. %.

In some embodiments, a gas recycle system 106 is arranged downstream of the absorption/condensation/hydration operation unit 103, adapted to recirculate the process recycle gas 34 via the recycle gas stream (D) to an upstream unit. The gas recycle system 106 may comprise any suitable one or more unit operations, including but not limited to gas ducting, dampers, valves, rotating equipment (e.g., fan, blower, blower, etc.) and a control system. A fan or blower may be employed to account for pressure drop across the acid plant system. The gas recycle system 106 may flowingly connect the absorption/condensation/hydration operation unit 103 to one or both of the sulfur dioxide generation operation unit 101 and the catalytic converter 102.

The destination of the process recycle gas 34 depends on a number of factors, including for example the flow rate and composition of the gases, and/or the equipment used. In some embodiments, the gas recycle system 106 flowingly connects the absorption/condensation/hydration operation unit 103 to the sulfur dioxide generation unit 101, arranged to recirculate the process recycle gas 34 to the sulfur dioxide generation unit 101. In some embodiments, the gas recycle system 106 flowingly connects the absorption/condensation/hydration operation unit 103 to the catalytic converter 102, arranged to recirculate the process recycle gas 34 to the catalytic converter 102 directly (i.e., without first passing through the sulfur dioxide generation unit 101). Recirculating at least part of the process recycle gas 34 directly into the catalytic converter 102 may assist to provide improved control of the temperature within the sulfur dioxide generation unit 101, thereby maintaining a safe and optimal acid plant operation. In some embodiments, one or more heat exchange units are arranged between the gas recycle system 106 and the sulfur dioxide generation unit 101 and/or the catalytic converter 102. In such embodiments, the process recycle gas 34 is caused to flow through one or more heat exchange units adapted to adjust a temperature thereof prior to being supplied into the sulfur dioxide generation unit 101 and/or the catalytic sulfur dioxide converter 102.

The control system may be used to adjust one or more operational parameters in the acid plant system to achieve a desired or an optimal plant performance and to maintain a safe acid plant at the desired range of operating conditions. Examples of such operational parameters include:
feed rate of the source of sulfur species;
feed rate of the source of strong oxygen gas;
flow rate and composition of the process gas;
flow rate and composition of the process recycle gas;
flow rate and composition of the process purge gas;
sulfuric acid plant capacity;
operating temperatures and/or system pressure;
etc.

In some embodiments, the system is maintained at an elevated pressure level. The system may be maintained at an elevated pressure of more than about 1 bar (a), and in some embodiments, between about 2 and 20 bar (a), and in some embodiments, between about 2 and 5 bar (a). In some embodiments, the source of strong oxygen gas 18 is supplied to the sulfur dioxide generation unit 101 at an elevated pressure. For example, in some embodiments, the source of strong oxygen gas 18 is pressurized to a desired elevated pressure prior to supplying to the sulfur dioxide generation unit 101. Higher operating pressures may have at least the advantages of allowing for reduction of equipment sizes and catalyst loadings, while enhancing sulfur trioxide generation in the sulfur dioxide generation unit 101 and the catalytic sulfur dioxide converter 102, and/or enhancing sulfur trioxide hydration and sulfuric acid condensation in the adsorption/condensation/hydration unit operation 103. The process and system of the present invention advantageously offer a low-cost pressurized plant operation. In some embodiments, a turboexpander may be arranged downstream of the sulfuric acid production process, for example, flowingly connected downstream of the absorption/condensation/hydration operation unit 103 configured to recover energy from the high-pressure process purge gas 31.

The inventors believe that the primary effect of maintaining excess sulfur dioxide or excess oxygen concentration in the process gas is to shift the thermodynamic equilibrium of Equation 1 towards greater sulfur trioxide production, while also utilizing excess reactants (sulfur dioxide or oxygen gas) as additional thermal heat sink and/or rate booster in the system. A process gas comprising strong sulfur dioxide and strong oxygen gas may be obtained through using a source of strong oxygen gas 18 and re-circulating at least part of the used process gas 32 as process recycle gas 34 in the system. Maintaining an excess sulfur dioxide concentration or an excess oxygen concentration in the system may achieve one or more of the following non-limiting desirable effects to the sulfuric acid plant:
Excess sulfur dioxide or oxygen gas in the sulfur dioxide generation unit operations 101 (e.g., sulfur burner, ore smelter, etc.) may serve as additional heat sink, thereby allowing the process gas temperature (e.g., the peak combustion flame temperature) to be maintained at the optimal range, e.g., between about 800° C. and about 2,000° C., and between about 900° C. and about 1,600° C. in embodiments in which the sulfur dioxide generation unit 101 comprises a sulfur burner.
Excess oxygen gas may enhance combustion/oxidation in the sulfur dioxide generation unit operations 101.
Excess sulfur dioxide or oxygen gas in the sulfur dioxide generation unit operations 101 shifts the thermodynamic equilibrium of Reaction 1 toward greater sulfur trioxide production as noted by Le Chatelier's principle. This may result in some sulfur dioxide oxidation upstream of the catalytic sulfuric dioxide converter 102 (i.e., pre-conversion), thereby allowing for a reduced required number of catalytic conversion stages (i.e., catalyst beds) and catalyst loadings in certain acid plant configurations.
Excess sulfur dioxide or oxygen gas in the sulfur dioxide generation unit operations 101 and/or the catalytic converter 102 may act as a rate booster in the sulfur dioxide oxidation process, thereby enhancing sulfur dioxide conversion and may advantageously reduce the number of required catalyst loadings. The enhanced sulfur dioxide conversion may enable efficient system operation by using 1 to 3 catalyst beds in the catalytic sulfur dioxide converter 102 and a single absorption/condensation/hydration unit operations 103 to achieve desired plant performance. The use of fewer number of catalyst beds and absorption/condensation/hydration unit operations in turn requires fewer pieces of heat exchange units and/or recovery equipment to be used.
Excess sulfur dioxide or oxygen gas in the catalytic converter 102 may serve as additional thermal heat sink, allowing the reactor temperature to be maintained within the desired range (e.g., between about 370° C. and about 650° C.) while maintaining high conversion rates.
Excess sulfur dioxide or oxygen gas in the catalytic sulfur dioxide converter 102 shifts the thermodynamic equilibrium of Reaction 1 toward greater sulfur trioxide generation, allowing reduced numbers of catalyst beds and catalyst loadings required for sulfur dioxide oxidation.
A strong sulfuric dioxide or strong oxygen gas may be obtained as a valuable co-product in the process purge gas.
SOx emissions may be notably reduced or eliminated, which may be attributed to the small flow rate of purge gas and enhanced sulfur dioxide conversion.
Excess sulfur dioxide or oxygen gas in the system may result in less heat losses and enhanced energy recovery, particularly if the system is designed to minimize purge and process gas flow rates. In some embodiments, the amount of steam that is co-generated in the present process is about 10% or greater than that generated in conventional single-absorption processes.
Excess sulfur dioxide or oxygen gas may enable the system to be operated at lower costs. Operating at elevated pressures may advantageously increase plant throughput, enhance sulfur dioxide oxidation, boost sulfur trioxide absorption/hydration/condensation, decrease catalyst loadings, and/or reduce equipment sizes.
Excess sulfur dioxide or oxygen gas may allow for the elimination of the plant main blower, by using the oxygen supply as the main driver for process gas, and/or elimination of the process gas dryer by implementing a water-free source of oxygen-containing gas.
Production of a source of strong oxygen gas 18 may additionally produces nitrogen, argon, and other rare gases, for example at an upstream air separation unit 201.

The actual desirable effects which may be observed in the implementation of the processes or apparatuses of the invention will depend on one or more of the applied process configuration (e.g., strong oxygen recycle gas or strong sulfur dioxide recycle gas), process design (e.g., number of catalyst beds, type of catalyst), and operating conditions (e.g., pressure, converter feed gas temperature, gas flow rates, etc.). All of such factors are adjustable to optimize plant performance and/or to achieve one or more of the above-noted desired effects.

### Example Embodiments

The invention is further described with reference to the following specific examples, which are not meant to limit the invention, but rather to further illustrate it. As illustrated in the following example embodiments, the plant configuration (e.g., strong oxygen gas or strong sulfuric dioxide gas in the process recycle gas 34, etc.), process design (e.g., number of catalyst beds, type of catalyst arranged in the catalytic sulfur dioxide converter 102, etc.) and operating conditions (e.g., pressure, converter feed gas temperature, etc.) of the process and apparatus of the present invention may be selected to achieve the desired performance (e.g., product selectivity, product yield, rate of conversion, SOx/NOx emission levels, produced heat levels, etc.). Any of the following examples may be further simplified, expanded, and/or integrated to suit the needs of a specific sulfuric acid site.

### Example Embodiment 1—Strong Sulfuric Dioxide Process

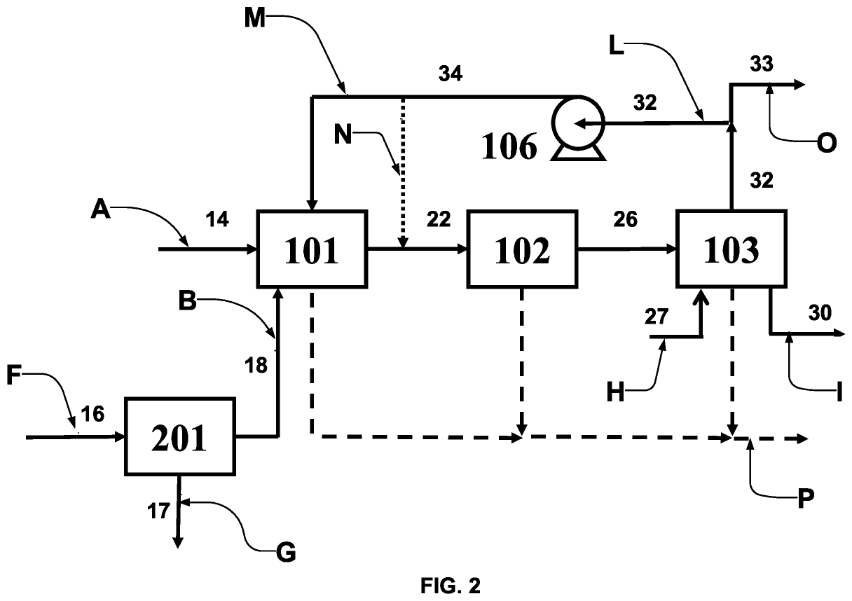

FIG. 2 illustrates an example embodiment of the process of the invention. This process design may be used to co-produce sulfuric acid, a strong sulfur dioxide gas, heat and a nitrogen rich gas. This example design embodiment features a strong sulfur dioxide recycle gas (i.e., process gas comprising excess sulfur dioxide gas) in the system. This process design may be utilized on acid plant sites where co-production of sulfuric acid and a strong sulfur dioxide gas is desired. FIG. 2 illustrates a sulfur-burning acid plant for simplicity; however, it would be understood that this example design embodiment may be applied to any other acid plants.

Referring to FIG. 2, air 16 is supplied to the upstream air separation unit 201 via an air stream (F). The upstream air separation unit 201 is configured to separate oxygen gas from the air 16, resulting with a gas 18 stream comprising strong oxygen gas. The gas stream air separation unit may additionally comprise other gases (e.g., N₂, Ar, etc.) 17 as a by-product, which may be caused to flow out of the system via gas by-product stream (G). In some embodiments, the other gases 17 comprise a nitrogen rich gas (i.e., the concentration of nitrogen in the other gases 17 is greater than about 79 vol. %). At least part of the strong oxygen gas that is generated by the upstream air separation unit 201 is supplied via the oxygen stream (B) to the sulfur dioxide generation unit operations 101 comprising a sulfur burner for use as the source of strong oxygen gas 18. An industrial-grade sulfur which is used as the source of sulfur species 14 may be supplied to the sulfur burner via the sulfur stream (A). Combustion of the industrial-grade sulfur 14 within the sulfur burner 101 produces a process gas comprising sulfur oxides. The sulfur oxides may predominantly comprise sulfur dioxide gas. A process gas comprising strong sulfur dioxide gas 22 may thus be produced from the combustion reaction. The excess sulfur dioxide may act as an additional thermal heat sink and performance booster in the sulfur burner 101. The high sulfur dioxide concentration in the sulfur burner 101 may initiate conversion of the sulfur dioxide gas to sulfur trioxide gas in the sulfur burner 101 (i.e., pre-conversion), such that a certain amount of sulfur trioxide gas may be generated prior to the catalytic conversion step in the catalytic converter 102.

The process gas comprising strong sulfur dioxide gas 22 is supplied to the catalytic sulfur dioxide converter 102, which comprises a single or multi-stage catalytic converter. In some embodiments, the catalytic sulfur dioxide converter 102 comprises a single catalytic converter, such that the process gas comprising strong sulfur dioxide gas 22 is caused to undergo a single catalytic conversion stage to produce the process gas comprising sulfur trioxide gas 26. Using a single catalytic conversion stage may be adequate to achieve efficient sulfur trioxide generation using the process and system of the present invention since the excess sulfur dioxide gas may advantageously serve as a thermal heat sink and performance booster in the acid plant.

The process gas comprising sulfur trioxide 26 is supplied to at least one absorption/condensation/hydration unit operation 103. Process water 27 may be supplied to the absorption/condensation/hydration unit operation 103 via water stream (H). The sulfur trioxide gas 26 and the process water 27 may be caused to react in the absorption/condensation/hydration unit operation 103 to produce the product stream comprising sulfuric acid 30. In some embodiments, only one absorption/condensation/hydration unit operation 103 is arranged in the acid plant system. One absorption/condensation/hydration unit operation 103 may be adequate to achieve efficient sulfuric acid production using the process and apparatuses of the present invention since the excess sulfur dioxide gas may advantageously result in enhanced sulfur trioxide generation in the upstream sulfur burner 101 and/or catalytic converter 102. The product stream comprising concentrated sulfuric acid 30 may be caused to flow out of the absorption/condensation/hydration unit operation 103 via product stream (I).

The used process gas 32 may also be caused to flow out of the absorption/condensation/hydration unit operation 103. In some example embodiments, the used process gas 32 is dry. The used process gas 32 may be substantially free of sulfur trioxide. In such example embodiments, the used process gas 32 comprises low oxygen gas content (i.e., less than about 10,000 ppmv, and in some embodiments, less than about 5,000 ppmv, and in some embodiments, less than about 2,000 ppmv), and rich in sulfur dioxide gas content (i.e., greater than about 12 vol. %, and in some embodiments, between about 30 to about 95% vol. %, and in some embodiments, between about 60 to about 85 vol. %).

At least part of the used process gas 32 comprising strong sulfur dioxide gas may be recirculated through the gas recycle system 106 via process gas stream (L) as process recycle gas 34 for supplying into the sulfur burner 101 via recycle stream (M) and/or the catalytic converter 102 via recycle streams (M) and (N) so as to supplement and/or replace the industrial-grade sulfur and oxygen rich gas in the acid plant system. In some embodiments, at least of the process recycle gas 34 optionally bypasses the sulfur burner 101 and is directly (with or without heat exchange) supplied to the catalytic converter 102 (e.g., via recycle stream N). Bypassing the sulfur burner 101 may advantageously enable control of the temperature within the sulfur burner 101, thereby maintaining a safe and optimal (e.g., high sulfur dioxide pre-conversion) acid plant operation.

The used process gas 32 may be purged prior to recirculation as recycle gas 34. Gas that is purged out of the process 33 may be discharged via a purge gas stream (O) comprising strong sulfur dioxide gas. Such process purge gas 33 comprising strong sulfur dioxide gas may be supplied to a downstream sulfur recovery unit, used onsite for other process units, and/or be treated (e.g., by means of compression and condensation, partial condensation, tail gas cleaning etc.) and optionally discharged to the atmosphere. The gas recycle system 106 may comprise a fan or blower, arranged upstream of the sulfur burner 101 and/or catalytic converter 102. The fan or blower may be employed to account for pressure drop across the acid plant system. In some embodiments, heat that is generated at each of one or more of the sulfur burner 101, catalytic converter 102 and the absorption/condensation/hydration unit operation 103 may be arranged to flow through a heat stream (P).

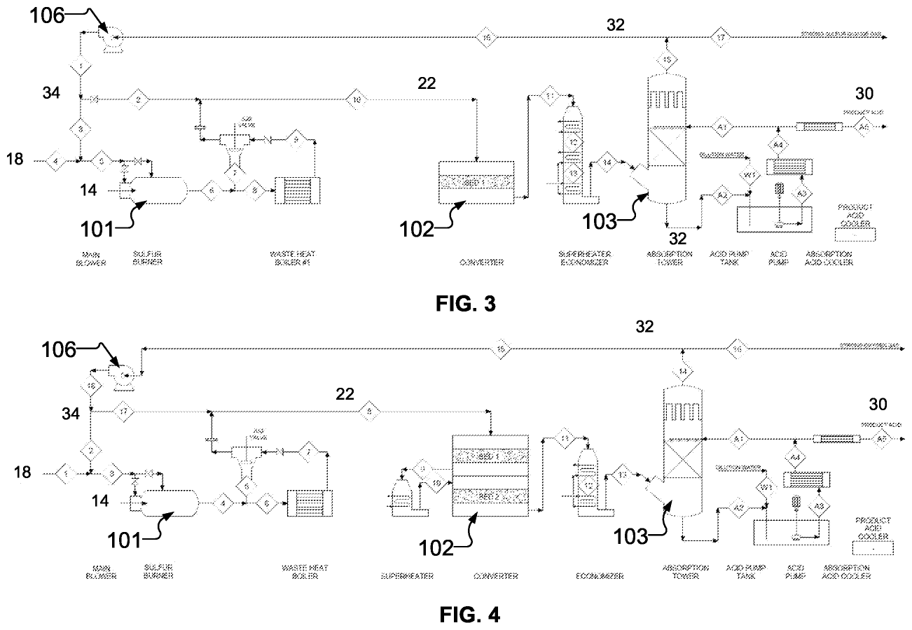

FIG. 3 is a detailed process flow diagram of the FIG. 2 embodiment of recirculating a strong sulfur dioxide recycle gas in the system. The FIG. 3 diagram illustrates that a number of conventionally required equipment in a sulfuric acid plant (e.g., a conventional double contact double absorption acid plant with chemical scrubbing) may be eliminated or reduced in size by recirculating a recycle process gas comprising strong sulfur dioxide into the upstream sulfur dioxide generation unit operations and/or catalytic converter. Some of those conventionally required equipment that may be eliminated include, but are not limited to, an air blower or compressor, a dry tower, one or more catalyst beds, an absorption/hydration unit, and one or more heat exchange equipment (e.g., hot/cold interpass heat exchangers).

This example embodiment may offer one or more of the following non-limiting advantages:
co-production of sulfuric acid, a strong sulfur dioxide gas, a nitrogen rich gas, and heat;
production of other gases (e.g., argon, krypton, xenon, etc.) by applying suitable processes in the upstream air separation unit 201 (e.g., cryogenic, pressure or vacuum swing adsorption, etc.);
small process and purge gas flow rates which may be dependent on the process design and operating conditions, advantageously reducing heat losses and enhancing energy recovery compared to that applied in conventional sulfuric acid plant systems;
low-cost pressurized plant operation upon supplying oxygen rich gas at elevated pressures;
reduction of equipment sizes and catalyst loadings, while enhancing sulfur trioxide generation in the sulfur burner and the catalytic converter, in particular when operating at higher system pressures;
enhance sulfur trioxide hydration and sulfuric acid condensation in the absorption/condensation/hydration unit operation, in particular at high operating pressures;
energy recovery from the high-pressure process purge gas by employing a turboexpander, etc.

Table 1 summarizes process evaluation results for different case studies related to the Example 1 embodiment. These case studies are based on a sulfur-burning acid plant which is designed to co-produce sulfuric acid and a strong sulfur dioxide gas. Plant acid capacity was maintained at 250 metric tons per day (MTPD) for illustrative purposes. The oxygen concentration in the source of strong oxygen gas was maintained at 94 vol. %, similar to the concentration that is typically obtained by vacuum-swing adsorption oxygen generators. Plant pressure was maintained at 4 bar (a) to take advantage of the low-cost pressurized operation from supplying into the system pressurized oxygen gas as the source of strong oxygen gas 18 obtained from the upstream air separation unit 201.

TABLE 1
Case studies for Example Embodiment 1

| | Case # | | | |
|---|---|---|---|---|
| | 1-A | 1-B | 1-C | 1-D |
| H₂SO₄ capacity (MTPD) | 250 | 250 | 250 | 250 |
| System pressure (bara) | 4 | 4 | 4 | 4 |
| Number of catalyst beds | 1 | 1 | 1 | 1 |
| Number of absorption units | 1 | 1 | 1 | 1 |
| Strong O₂ feed strength (vol. %) | 94% | 94% | 94% | 94% |
| Strong O₂ feed flow rate (kmol · h⁻¹) | 433 | 291 | 198 | 175 |
| Recycle gas total flow rate (kmol · h⁻¹) | 1067 | 684 | 724 | 909 |
| % Recycle gas fed to burner | 100% | 100% | 100% | 100% |
| % Recycle gas fed to catalyst bed | 0% | 0% | 0% | 0% |
| Recycle gas SO₂ strength (vol. %) | 91% | 87% | 69% | 35% |
| Purge gas flow rate (kmol · h⁻¹) | 274 | 133 | 38 | 16 |
| Purge gas SO₂ strength (vol. %) | 91% | 87% | 69% | 35% |
| Purge gas O₂ strength (ppmv) | 9.76 | 275 | 504 | 1257 |
| Burner outlet temperature (° C.) | 1500 | 1480 | 1120 | 1019 |
| SO₂ pre-conversion in burner (%) | 0.4% | 0.6% | 2.9% | 5.0% |
| Bed 1 outlet temperature (° C.) | 554 | 629 | 629 | 629 |
| Overall oxygen utilization (%) | +99% | +99% | +99% | +99% |
| Steam capacity (kg steam at 31 bar(a) | 4.2 | 2.8 | 1.8 | 1.5 |
| and 302° C. /kg acid) | | | | |
| SO₂/H₂SO₄ ratio (kg SO₂/kg acid) | 1.52 | 0.71 | 0.16 | 0.04 |

Results of the different case studies show that efficient co-production of sulfuric acid and a strong sulfur dioxide gas is attainable by applying the process and apparatus of the invention. The production rate and purity of the strong sulfur dioxide gas (i.e., co-product) may be optimized by adjusting one or more of the parameters in the process design and/or operating conditions. Results show that a high rate of superheated steam generation can be achieved by the acid plant system described in the present invention embodiment.

### Example Embodiment 2—Strong Oxygen Gas Process

In this example embodiment, sulfuric acid, a strong oxygen gas, heat and a nitrogen rich gas are co-produced by applying the example process design schematically illustrated in FIG. 2. This example embodiment features a strong oxygen recycle gas (i.e., process gas comprising excess oxygen gas) in the system. This example design embodiment may be utilized on acid plant sites where low SOx emissions and/or co-production of sulfuric acid and a strong oxygen gas is desired.

This example embodiment applies the same process as the one described in Example Embodiment 1, with the exception that the used process gas 32 that is arranged to flow out of the absorption/condensation/hydration unit operation 103 comprises strong oxygen gas. At least part of the process gas 32 comprising strong oxygen gas is caused to be recirculated as process recycle gas 34 comprising strong oxygen gas through the gas recycle system 106 into the sulfur burner 101 (e.g., via recycle stream M) and/or the catalytic converter 102 (e.g., either directly via recycle stream M or indirectly via recycle stream N). In such example embodiments, gas that is purged out of the process 33 comprises strong oxygen gas. The process purge gas comprising strong oxygen gas 33 may be used as a by-product, and/or be discharged to the atmosphere with or without any post gas treatment.

This example embodiment may offer the same non-limiting advantages as listed in respect of Example Embodiment 1, with the addition of one or more of the following:
co-production of sulfuric acid, a strong oxygen gas, a nitrogen rich gas, and heat;
provide a safe and efficient system operation since the excess oxygen gas in the process gas may serve as additional thermal heat sink in the sulfur burner and the catalytic converter which thus helps to control the temperature rise in the sulfur burner and the catalytic converter;
enhance sulfur dioxide conversion since the excess oxygen gas in the process gas may act as a performance booster (i.e., equilibrium shifter and rate booster) in the sulfur burner 101 and/or the catalytic converter 102. This may also minimize SOx emissions (defined as amount SOx emitted per ton acid produced) from the system. This invention embodiment may be capable of offering low or nearly zero SOx emissions at certain process designs and operating conditions;
reduction of the number of catalytic conversion stages and catalyst loadings required for efficient sulfur trioxide generation due to enhanced sulfur dioxide conversion. In some example embodiments, 1 to 3 stages of catalytic conversion stages may be arranged within the catalytic converter. The number of catalytic conversion stages to provide in the system may be adjusted depending on the target process SOx emissions and/or the applied operating conditions (e.g., oxygen concentration in the oxygen rich gas, system pressure, etc.);
use of a single absorption/condensation/hydration unit operation for efficient production of sulfuric acid due to the enhanced sulfur dioxide conversion in the sulfur burner and/or the catalytic converter; etc.

FIG. 4 is a detailed process flow diagram for the Example 2 embodiment of recirculating a strong oxygen recycle gas in the system. The FIG. 4 diagram illustrates that a number of conventionally required equipment in a sulfuric acid plant (e.g., a conventional double contact double absorption acid plant with chemical scrubbing) may be eliminated or reduced in size by recirculating a recycle gas comprising strong oxygen gas into the upstream sulfur dioxide generation unit operations 101 and/or catalytic converter 102. Some of those conventionally required equipment that may be eliminated include, but are not limited to, an air blower or compressor, a dry tower, one or more catalyst beds or catalytic conversion stages, an absorption unit, and heat exchange equipment.

Table 2 summarizes process evaluation results for different case studies related to the Example 2 embodiment. The case studies are based on a sulfur-burning acid plant which is designed to co-produce sulfuric acid and a strong oxygen gas. Plant acid capacity was maintained at 250 metric tons per day (MTPD) for illustrative purposes. The oxygen concentration in the source of strong oxygen gas 18 was 90 and 94 vol %. Plant pressure was maintained at 1 bar (a) and 4 bar (a).

TABLE 2
Case studies for Example Embodiment 2

| | Case # | | | |
|---|---|---|---|---|
| | 2-A | 2-B | 2-C | 2-D |
| H₂SO₄ capacity (MTPD) | 250 | 250 | 250 | 250 |
| System pressure (bara) | 4 | 4 | 1 | 1 |
| Number of catalyst beds | 2 | 2 | 2 | 3 |
| Number of absorption units | 1 | 1 | 1 | 1 |
| Strong O₂ feed strength (vol. %) | 94% | 90% | 94% | 94% |
| Strong O₂ feed flow | 179 | 194 | 180 | 175 |
| rate (kmol · h⁻¹) | | | | |
| Recycle gas total flow | 1252 | 957 | 960 | 1366 |
| rate (kmol · h⁻¹) | | | | |
| % Recycle gas fed to burner | 83% | 100% | 100% | 79% |
| % Recycle gas fed | 17% | 0% | 0% | 21% |
| to 1^{st} catalyst bed | | | | |
| Recycle gas O₂ strength (vol. %) | 44% | 43% | 48% | 33% |
| Purge gas flow rate (kmol · h⁻¹) | 19 | 34 | 20 | 16 |
| Purge gas O₂ strength (vol. %) | 44% | 43% | 48% | 33% |
| Purge gas SO₂ strength (ppmv) | 767 | 1277 | 3832 | 1111 |
| Burner outlet temperature (° C.) | 1000 | 1002 | 1031 | 989 |
| SO₂ pre-conversion in burner (%) | 16% | 16% | 8% | 9% |
| Bed 1 outlet temperature (° C.) | 599 | 620 | 628 | 592 |
| Bed 2 outlet temperature (° C.) | 456 | 468 | 493 | 470 |
| Bed 3 outlet temperature (° C.) | — | — | — | 440 |
| O₂ utilization for | 95% | 92% | 94% | 97% |
| acid production (%) | | | | |
| Steam capacity (kg steam at 31 | 1.46 | 1.48 | 1.50 | 1.47 |
| bar(a) and 302° C. /kg acid) | | | | |
| SOx emissions (kg SO₂/ton acid) | 0.09 | 0.27 | 0.49 | 0.11 |

Results of the different case studies show that efficient co-production of sulfuric acid and a strong oxygen gas is attainable by applying the process and apparatus of the invention. The production rate and purity of the strong oxygen gas (i.e., the co-product) may be optimized by adjusting one or more of the parameters in the process design and operating conditions.

For comparative purposes, SOx emissions from operating conventional double contact double absorption acid plant systems are typically greater than 2 kg SO₂/ton acid. The emissions level may be reduced to about 0.2 kg SO₂/ton acid through installing a downstream chemical scrubbing unit (regenerative or non-regenerative). Implementing a chemical scrubbing unit may however impose significant capital, maintenance, and operational costs to the acid plant system. In addition, non-regenerative chemical scrubbers require continuous purging and handling of byproducts which further complicates the operation of the system. Similar or lower SOx emission levels may be achieved by operating the process of the present invention, as compared to the levels from operating conventional sulfuric acid production processes, which the present invention advantageously does not require a downstream chemical scrubber, as shown in Table 2. Fewer pieces of equipment (e.g., 2-3 catalyst bed, single absorption unit, fewer heat exchangers, etc.) may be used to operate the process of the present invention as compared to the number of pieces of equipment required for conventional acid plant systems. SOx emissions in the present invention may be controlled through adjusting different operational parameters (e.g., bed inlet temperature, pressure, oxygen feed purity, recycle flow rate, purge fraction, etc.) and process configurations (e.g., number of catalyst beds, number of hydration units, etc.), advantageously providing flexibility for process optimization based on the target acid site SOx emissions. The process purge gas generated by this example embodiment may contain relatively high sulfur dioxide gas trace concentrations (e.g., greater than about 500 ppmv), in addition to the high oxygen gas concentrations. Such relatively high sulfur dioxide gas concentrations may allow for efficient SOx removal using conventional gas cleaning technologies (e.g., scrubber), thereby allowing for significant reductions in SOx emissions in the acid plant and possibly allowing for a nearly zero acid plant SOx emissions by arranging a gas cleaning unit downstream of the absorption/condensation/hydration unit operation 103.

### Example Embodiment 3—Process with Reduced Gas Flow Rate

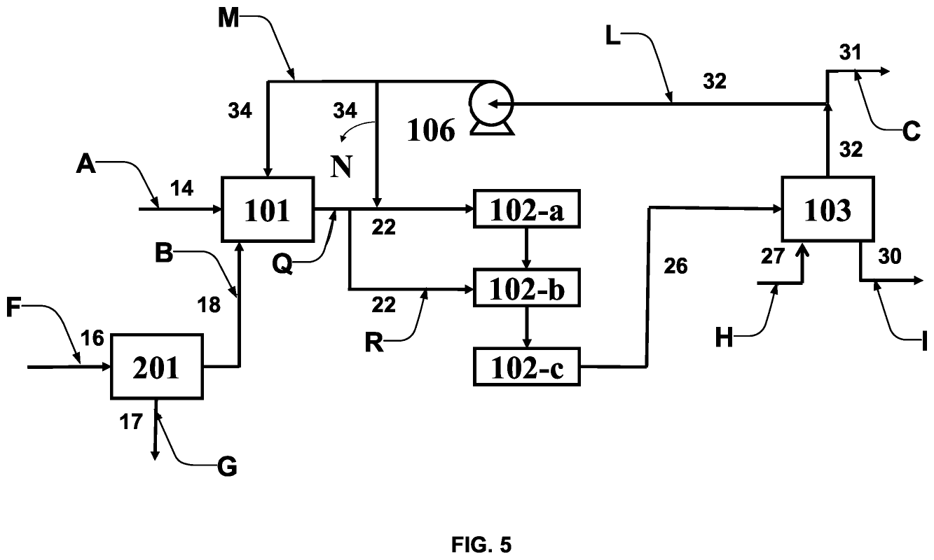

FIG. 5 illustrates another example embodiment of the process and system of the invention. This process design may be used to optimize or minimize the process gas flow rates that are necessary to achieve the desired acid plant performance based on the acid site requirements (e.g., allowable acid plant SOx emissions). This example embodiment may be implemented on any type and configuration of sulfuric acid plants although FIG. 5 illustrates a sulfur-burning acid plant having a sulfur dioxide generation unit operation 101 comprising a sulfur burner as an example. This embodiment is applicable to both process configurations described in Example Embodiment 1 (i.e., process gas with excess sulfur dioxide gas) and Example Embodiment 2 (i.e., process gas with excess oxygen gas).

The system and process of this example embodiment is similar to the systems and processes described in relation to Example Embodiments 1 and 2 above, with the exception that in this example embodiment, the catalyst converter 102 comprises at least two catalytic conversion stages (i.e., catalyst beds). Referring to FIG. 5, the catalytic converter 102 comprises three catalytic conversion stages, 102-a, 102-b, and 102-c. In this example embodiment, at least some of the process gas comprising sulfur dioxide gas 22 that is caused to flow out of the sulfur burner 101 is split into a plurality of streams (e.g., Streams Q and R into each of stages 102-a and 102-b respectively in the illustrated embodiment) for supplying into the two or more catalytic conversion stages. The process gas 22 may be split evenly or unevenly between the plurality of streams. The process gas 22 may in some embodiments, be caused to flow into one or more heat exchange units, configured to adjust a temperature thereof before being supplied into the two or more catalytic conversion stages. In some other embodiments, the process gas 22 is supplied into the two or more catalytic conversion stages directly without first being supplied into one or more heat exchange units. Heat recovery units and streams may be flowingly connected to one or more of the unit operations 101, 102-a, 102-b, 102-c, 103, but such are not illustrated in FIG. 5 for simplicity.

The splitting of the process gas comprising sulfur dioxide gas 22 into a plurality of streams for supplying into two or more catalytic conversion stages may decrease the gas flow rates required to operate the sulfuric acid production process, advantageously preventing overheating of the operation units (e.g., catalytic converter 102) which may be attributed to a better controlled sulfur dioxide gas oxidation and heat dissipation in the first catalyst bed (e.g., conversion stage 102-a). Lower gas flow rates may enhance heat recovery, reduce heat losses, and require smaller equipment sizes in the acid plant system. Retrofitting of existing equipment may be possible.

This process design may result in higher SOx emissions compared to emissions resulting from operating Example Embodiment 2 with similar process design (e.g., number of catalyst beds, number of absorption units, etc.) and operating conditions (e.g., system pressure, oxygen feed purity, recycle and purge flow, etc.). This may be mitigated through several potential routes, including but not limited to, installing additional catalyst beds, utilizing one or more catalysts with low strike temperature (preferably in the first and/or the last catalyst beds of the catalytic converter 102), elevating the system pressure, adjusting the recycle and/or purge flow rates, increasing oxygen feed purity, etc.

### Example Embodiment 4—Process comprising Sulfide Ores as a Sulfur Source

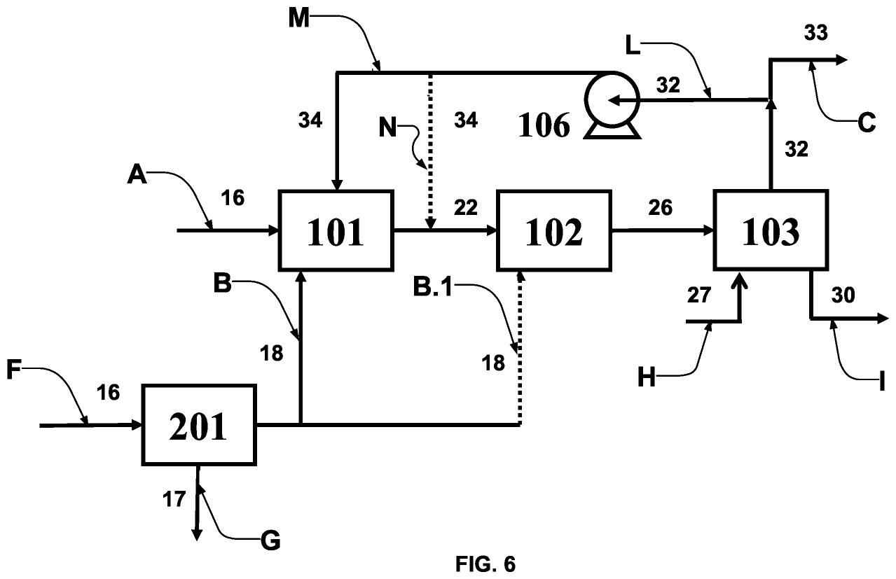

The FIG. 6 example process design may be used to co-produce sulfuric acid, a strong sulfur dioxide gas or strong oxygen gas, heat, and a nitrogen rich gas using sulfide ores, a source of strong oxygen gas, and process water as reactants. This embodiment may be implemented on pyrometallurgical acid plants where low SOx emissions and/or co-production of sulfuric acid and a strong oxygen gas or sulfur dioxide gas is desired. In some embodiments, the use of a recycle gas comprising strong oxygen gas (i.e., process gas with excess oxygen gas) is preferred for operating this example process design and such will be used to describe this example embodiment; however it is understood that a recycle gas comprising strong sulfur dioxide gas (i.e., process gas with excess sulfur dioxide gas) may also be used. Heat recovery units and streams may be flowingly connected to one or more of the unit operations 101, 102, 103, but such are not illustrated in FIG. 6 for simplicity.

The process of this example embodiment is similar to the process described in relation to Example Embodiment 2 above with the exception that in this example, the sulfur dioxide generation unit operation 101 comprises a pyrometallurgical extraction unit operation 101. A pyrometallurgical extraction unit operation 101 may comprise an ore smelter, a quench/humidifying tower, a gas cleaning unit (e.g., scrubber), a gas cooling tower, a wet electrostatic precipitator, a gas blower, and a dry tower.

Sulfide ore may be thermally treated in an ore smelter of the pyrometallurgical extraction unit operation 101. Thermally treating the sulfide ore may generate a process gas containing one or more of dust, fumes, SO₂, SO₃, O₂, H₂O, CO₂, volatile metals, inert gases, and trace contaminants. All or part of the recycle gas comprising strong oxygen gas 32 and/or the source of strong oxygen species 18 may be used to provide an oxygen enriched environment in the ore smelter. In some embodiments, the process gas flowing out of the ore smelter is caused to flow into one or more suitable gas cleaning unit operations downstream of the ore smelter, configured to clean the process gas to generate a process gas comprising sulfur dioxide 22 that is suitable for sulfuric acid production.

The process gas generated from the ore smelter 22 is supplied into the catalytic converter 102 within which the sulfur dioxide gas is oxidized to sulfur trioxide gas. Remaining parts of the recycle gas comprising strong oxygen gas 34 and/or the source of strong oxygen species 18 (which have not been supplied into the ore smelter) may be supplied into the catalytic converter 102 via for example recycle stream N and oxygen stream B.1 respectively, providing the oxygen for sulfur dioxide gas oxidation, and/or maintaining excess oxygen concentration in the catalytic beds. The catalytic converter 102 and the absorption/condensation/hydration unit operation 103 in this process embodiment share similar working principles to that described for Example Embodiment 2 so such will not be repeated here for brevity. At least part of the used process gas 32 which flow out of the absorption/condensation/hydration unit operation is arranged to be recycled to the pyrometallurgical extraction unit operation 101 and/or the catalytic converter 102 as recycle gas 34.

This process design may feature a concentrated oxygen gas environment in the ore smelter, which may facilitate with enhancing the rate and extent of ore smelting, while reducing the size of equipment and unit operations required to operate the process to achieve the desired plant performance. The concentration of oxygen gas in the ore smelter may be adjusted by changing one or more of the recycle gas flow rate, purge gas flow rate, oxygen concentration in the source of oxygen species, flow rate of the source of oxygen gas, etc. This advantageously provides flexibility for system operation and optimization. This process design may also feature a low inert (e.g., nitrogen gas) content in the sulfuric acid plant, which may be attributed to the high concentration of oxygen gas in the source of strong oxygen species. Low nitrogen concentrations in unit operations that are operated at high temperatures (e.g., ore smelter) may notably reduce levels of NOx formation and emissions in the acid plant. Lower inert gas content in the process gas may also allow for reduction in the required equipment sizes and enhanced heat recovery in the system.

### Example Embodiment 5—Process comprising Decomposition of Spent Sulfuric Acid

In this example embodiment, concentrated sulfuric acid, a strong sulfur dioxide gas or strong oxygen gas, heat, and a nitrogen rich gas are co-produced using spent sulfuric acid, a source of strong oxygen gas, and process water by applying the example process design schematically illustrated in FIG. 6. This embodiment may be implemented on acid regeneration sites where low SOx emissions and/or co-production of sulfuric acid and a strong oxygen gas or strong sulfur dioxide gas is desired. Process recycle gas comprising strong oxygen gas will be used to describe this example embodiment; however it is understood that a recycle gas comprising strong sulfur dioxide gas may also be used.

The process of this example embodiment is similar to the process described in relation to Example Embodiment 2 above with the exception the sulfur dioxide generation unit operation 101 comprises an acid decomposition unit operation 101. An acid decomposition unit operation 101B may comprise an acid regeneration furnace, gas cleaning equipment, and heat recovery equipment. A gas drying unit may also be installed depending on the type of catalyst used for sulfur dioxide gas oxidation.

Spent sulfuric acid may be decomposed to sulfur dioxide gas, oxygen gas, water, and sulfur trioxide gas in an acid regeneration furnace of the acid decomposition unit operation 101. The decomposition may be performed at a temperature in the range of from about 900° C. to about 1300° C. In some embodiments, the heat that is required to perform the acid thermal decomposition process is supplied through burning a fuel mixture (e.g., hydrocarbon fuels, methane, H₂S, sulfur, ammonia, etc.) inside the acid regeneration furnace. In some embodiments, the oxygen that is required for fuel burning is supplied through feeding at least part of the process recycle gas comprising strong oxygen gas 34 and/or the source of strong oxygen gas 18 into the acid regeneration furnace. The acid decomposition unit operation 101 may generate, from the decomposition of spent sulfuric acid, a process gas comprising one or more of sulfur dioxide gas, water, oxygen gas, sodium trioxide gas, inert gases, and other trace gases. The composition of the process gas generated from the decomposition process may vary, depending on a number of factors including but not limited to, the flow rate and composition of the fuel, the flow rate and composition of the spent sulfuric acid, the flow rate and composition of the source of strong oxygen gas, the flow rate and composition of recycle gas, the desired acid regeneration furnace temperature, and/or target oxygen gas and sulfur trioxide gas concentration in the acid regeneration furnace off-gas, etc.

The process gas comprising sulfur dioxide 22 that is produced at the acid decomposition unit operation 101 may be supplied into a single or multi-stage catalytic converter 102 within which sulfur dioxide gas is oxidized to sulfur trioxide gas. The remaining parts of the recycle gas comprising strong oxygen gas 34 and/or the source of strong oxygen species 18 (i.e., gas that have not been supplied into the acid decomposition unit operation 101) may be supplied into the catalytic converter via Streams N and B.1 respectively, providing the oxygen for sulfur dioxide oxidation, and/or maintaining excess oxygen concentration in the system. The catalytic converter 102 and the absorption/condensation/hydration unit operation 103 in this process embodiment share similar working principles to that described for Example Embodiment 2, so such will not be repeated here for brevity. At least part of the used process gas 32 arranged to flow out of the absorption/condensation/hydration unit operation 103 is recycled to the acid decomposition unit operation 101 and/or the catalytic converter 102 as process recycle gas 34.

This process design may feature a low inert gas content (particularly nitrogen gas) in the process gas, which may be attributed to the high concentration of oxygen gas in the source of strong oxygen gas 18. This may advantageously reduce NOx emissions in the acid regeneration furnace, thereby allowing for higher operating temperatures within the furnace. High operating temperatures may facilitate sulfur trioxide generation in the acid regeneration furnace, thereby enhancing sulfur recovery (i.e., less sulfur trioxide gas losses in gas cleaning equipment). Lower inert gas content contained in the process gas may also allow for reduction in the sizes of the required equipment and/or enhanced heat recovery in the system.

Throughout the foregoing description and the drawings, in which corresponding and like parts are identified by the same reference characters, specific details have been set forth in order to provide a more thorough understanding to persons skilled in the art. However, well known elements may not have been shown or described in detail or at all to avoid unnecessarily obscuring the disclosure.

As will be apparent to those skilled in the art in the light of the foregoing disclosure, many alterations and modifications are possible in the practice of this invention without departing from the scope thereof. Accordingly, the description and drawings are to be regarded in an illustrative, rather than a restrictive, sense.

1. A process for producing sulfuric acid in a sulfuric acid plant system, comprising the steps of:
(a) reacting a source of sulfur species (14) and a source of strong oxygen gas (18) in a sulfur dioxide generation unit (101) to produce a process gas comprising sulfur dioxide (22);
(b) supplying the process gas comprising sulfur dioxide gas to a catalytic converter (102) configured to oxidize the sulfur dioxide gas to produce a process gas comprising sulfur trioxide (26);
(c) supplying the process gas comprising sulfur trioxide to an absorption/condensation/hydration unit operations (103) configured to hydrate the sulfur trioxide to produce sulfuric acid (30) and a used process gas (32);
(d) purging part of the used process gas (32), thereby producing a stream of process purge gas (33) and a stream of process recycle gas (34); and
(e) recirculating at least part of the process recycle gas into one or both of the sulfur dioxide generation unit and the catalytic converter, wherein the streams of process recycle gas and process purge gas each comprises an excess concentration of sulfur dioxide gas of greater than about 12 vol. %, or an excess concentration of oxygen gas of greater than about 21 vol. %.

2. The process as defined in claim 1, further comprising collecting the sulfur dioxide gas or oxygen gas contained in the process purge gas as a by-product.

3. The process as defined in claim 1, wherein the concentration of oxygen in the source of strong oxygen gas is greater than about 21 vol. %.

4. The process as defined in claim 1, wherein the concentration of oxygen in the source of strong oxygen gas is greater than about 80 vol. %.

5. The process as defined in claim 1, wherein the concentration of oxygen in the source of strong oxygen gas is greater than about 90 vol. %.

6. The process as defined in claim 1, wherein the pressure within the sulfuric acid plant system is maintained between about 1 bar (a) and about 20 bar (a).

7. The process as defined in claim 1, wherein the pressure within the sulfuric acid plant system is maintained between about 2 bar (a) and about 5 bar (a).

8. The process as defined in claim 1, wherein the source of strong oxygen gas is produced by separating gas from an air supply at an air separation unit arranged upstream of the sulfur dioxide generation unit, wherein the separated gas comprises oxygen gas.

9. The process as defined in claim 8, wherein the separating of the gas from the air supply additionally produces a nitrogen rich gas, wherein the concentration of nitrogen contained in the nitrogen rich gas is greater than about 79 vol. %.

10. The process as defined in claim 8, wherein the separated gas additionally comprises one or more noble gases.

11. The process as defined in claim 10, wherein the one or more noble gases is selected from the group consisting of krypton, argon, and xenon.

12. The process as defined in claim 1, wherein the excess concentration of sulfur dioxide gas contained in each of the streams of process recycle gas and process purge gas is between about 12 and 99 vol. %.

13. The process as defined in claim 1, wherein the excess concentration of sulfur dioxide gas contained in each of the streams of process recycle gas and process purge gas is between about 30 and 95 vol. %.

14. The process as defined in claim 1, wherein the excess concentration of sulfur dioxide gas contained in each of the streams of process recycle gas and process purge gas is between about 60 and 90 vol. %.

15. The process as defined in claim 1, wherein the excess concentration of oxygen gas contained in each of the streams of process recycle gas and process purge gas between about 21 and 99 vol. %.

16. The process as defined in claim 1, wherein the excess concentration of oxygen gas contained in each of the streams of process recycle gas and process purge gas between about 30 and 90 vol. %.

17. The process as defined in claim 1, wherein the excess concentration of oxygen gas contained in each of the streams of process recycle gas and process purge gas between about 35 and 50 vol. %.

18. The process as defined in claim 1, further comprising the step of (f) supplying at least part of the source of strong oxygen gas into the catalytic converter.

19. The process as defined in claim 1, wherein the catalytic converter comprises one to three catalyst beds.

20. The process as defined in claim 1, wherein the catalytic converter comprises two or more catalyst beds.

21. The process as defined in claim 20, wherein the step of supplying the process gas comprising sulfur dioxide gas to the catalytic converter comprises splitting the process gas into two or more streams, and supplying each of the two or more streams into a respective one of the two or more catalyst beds.

22. The process as defined in claim 20, wherein the catalytic converter comprises at least three catalyst beds, the at least three catalyst beds comprising a first catalyst bed, a second catalyst bed, and a final catalyst bed, and wherein the step of supplying the process gas comprising sulfur dioxide gas to the catalytic converter comprises splitting the process gas into at least two streams, and supplying the at least two streams into the respective first and second catalyst beds, and wherein the first and second catalyst beds are arranged upstream of the final catalyst bed, and wherein the process gas is caused to flow out of the catalytic converter after flowing through the final catalyst bed.

23. The process as defined in claim 21, wherein the two or more streams comprise equal amounts of the process gas or unequal amounts of the process gas.

24. The process as defined in claim 21, wherein the two or more streams are arranged to flow through a heat exchanger for adjusting a temperature thereof, before supplying into the respective one of the two or more catalyst beds.

25. The process as defined in claim 1, wherein the recirculating step (e) comprises bypassing the sulfur dioxide generation unit and recirculating the at least part of the process recycle gas directly into the catalytic converter.

26. The process as defined in claim 25, wherein the at least part of the process recycle gas is supplied directly into a first catalyst bed of the catalytic converter, wherein the catalytic converter comprises a plurality of catalyst beds comprising at least the first catalyst bed and a final catalyst bed, and wherein the process gas is caused to flow out of the catalytic converter after flowing through the final catalyst bed.

27. The process as defined in claim 1, wherein the reacting of the source of sulfur species and the source of strong oxygen gas in step (a) further comprises pre-converting sulfur dioxide gas into sulfur trioxide gas in the sulfur dioxide generation unit before supplying the process gas comprising sulfur dioxide gas to the catalytic converter in step (b).

28. The process as defined in claim 1, further comprising the step of maintaining a temperature within the sulfur dioxide generation unit between about 800° C. and about 2,000° C. by recirculating at least part of the process recycle gas into the sulfur dioxide generation unit.

29. The process as defined in claim 1, further comprising the step of maintaining a gas temperature within the catalytic converter below about 650° C. by recirculating at least part of the process recycle gas into the catalytic converter.

30. The process as defined in claim 1, wherein the used process gas produced in step (c) additionally comprises one or more inert gases.

31. The process as defined in claim 1, wherein the step of producing the process gas comprising sulfur dioxide is performed by thermal decomposing within an acid regeneration furnace, and wherein the thermal decomposing comprises applying a heat to burn a fuel mixture inside the acid regeneration furnace, and wherein the heat is generated by supplying at least part of the one or both of the source of strong oxygen gas and the process recycle gas comprising the excess concentration of oxygen gas into the acid regeneration furnace.

32. The process as defined in claim 1, further comprising flowing the stream of process purge gas to a turboexpander arranged downstream of the absorption/condensation/hydration unit operations configured to recover energy therefrom.

33. The process as defined in claim 1, wherein the streams of process recycle gas and process purge gas each comprises an excess concentration of sulfur dioxide gas of greater than about 12 vol. % and an oxygen concentration of less than about 2,000 ppmv.

34. The process as defined in claim 1, wherein the streams of process recycle gas and process purge gas each comprises an excess concentration of sulfur dioxide gas of greater than about 12 vol. %, and wherein the process recycle gas is in the range of from about 30 vol. % to about 99 vol. % of the used process gas.

35. The process as defined in claim 1, wherein the streams of process recycle gas and process purge gas each comprises an excess concentration of oxygen gas of greater than about 21 vol. %, and wherein the process recycle gas is in the range of from about 30 vol. % to about 99 vol. % of the used process gas.

36. A process for producing sulfuric acid in a sulfuric acid plant, comprising the steps of:
(a) reacting a source of sulfur species (14) and a source of strong oxygen gas (18) having an excess concentration of oxygen of greater than about 21 vol. % in a sulfur dioxide generation unit (101) to produce a process gas comprising sulfur dioxide (22);
(b) supplying the process gas comprising sulfur dioxide gas into a catalytic converter (102) configured to oxidize the sulfur dioxide gas to produce a process gas comprising sulfur trioxide (26);
(c) supplying the process gas comprising sulfur trioxide into an absorption/condensation/hydration unit operations (103) configured to hydrate the sulfur trioxide to produce sulfuric acid (30) and a used process gas (32); and
(d) recirculating at least part of the used process gas as a stream of process recycle gas (34) into one or both of the sulfur dioxide generation unit and the catalytic converter, wherein the stream of process recycle gas comprises an excess concentration of sulfur dioxide gas of greater than about 12 vol. %.

37. The process as defined in claim 36, wherein the source of strong oxygen gas comprises an excess concentration of oxygen of greater than about 80 vol. %.

38. The process as defined in claim 36, wherein the concentration of oxygen in the source of strong oxygen gas is greater than about 90 vol. %.

39. The process as defined in claim 36, further comprising purging part of the used process gas, thereby producing a stream of process purge gas (33) and the stream of process recycle gas.

40. The process as defined in claim 39, wherein the stream of process purge gas and the stream of process recycle gas each comprises an excess concentration of sulfur dioxide gas between about 30 and about 95 vol. % and a concentration of oxygen gas of less than about 10,000 ppmv.

41. The process as defined in claim 36, wherein the process recycle gas is in the range of from about 30 vol. % to about 100 vol. % of the used process gas.

42. A process for producing sulfuric acid in a sulfuric acid plant, comprising the steps of:
(a) reacting a source of sulfur species (14) and a source of strong oxygen gas (18) having an excess concentration of oxygen of greater than about 21 vol. % in a sulfur dioxide generation unit (101) to produce a process gas comprising sulfur dioxide (22);
(b) supplying the process gas comprising sulfur dioxide gas into a catalytic converter (102) configured to oxidize the sulfur dioxide gas to produce a process gas comprising sulfur trioxide (26);
(c) supplying the process gas comprising sulfur trioxide into an absorption/condensation/hydration unit operations (103) configured to hydrate the sulfur trioxide to produce sulfuric acid (30) and a used process gas (32); and
(d) recirculating at least part of the used process gas as a stream of process recycle gas (34) into one or both of the sulfur dioxide generation unit and the catalytic converter, wherein the stream of process recycle gas comprises an excess concentration of oxygen gas of greater than about 21 vol. %.

43. The process as defined in claim 42, wherein the excess concentration of oxygen gas contained in the stream of process recycle gas is between about 30 and 90 vol. %.

44. The process as defined in claim 42, wherein the excess concentration of oxygen gas contained in the stream of process recycle gas is between about 35 and 50 vol. %.

45. The process as defined in claim 42, wherein the process recycle gas is in the range of from about 30 vol. % to about 100 vol. % of the used process gas.

46. The process as defined in claim 42, wherein the process recycle gas is in the range of from about 80 vol. % to about 100 vol. % of the used process gas.

47. The process as defined in claim 42, wherein the process recycle gas is in the range of from about 95 vol. % to about 100 vol. % of the used process gas.
